(19) United States
(12) Patent Application Publication
(10) Pub. No.: US 2001/0001353 A1
(43) Pub. Date: May 24, 2001

(54) Trap for insects and small rodents

(76) Inventor: Robert Jones, New Orleans, LA (US)

Correspondence Address: THOMAS S. KEATY, KEATY PROFESSIONAL LAW CORP., 2140 WORLD TRADE CENTER, NO. 2 CANAL STREET, NEW ORLEANS, LA, 70130, US

(21) Appl. No.: 09/761,421

(22) Filed: Jan. 16, 2001

Related U.S. Application Data
(63) Continuation-in-part of application No. 09/232,258, filed on Jan. 19, 1999.

(51) Int. Cl. A01N 25/34; A01M 1/14

(52) U.S. Cl. 43/114; 424/414

(57) ABSTRACT

A trap for small insects and rodents has a shallow tray with a bottom plate and a continuous side wall. A contiguous lip extends along the periphery of the side wall and substantially perpendicularly thereto. A narrow protuberance extends from the lip to elevate one side of the tray above a mounting surface when the tray is placed with an outer surface of the bottom plate facing upwardly. A layer of adhesive substance is deposited on an inner surface of the bottom plate. A small amount of bait is placed on the adhesive layer. When the trap is placed with the inner surface facing down, the upper surface becomes inclined to trap even smaller insects trying to escape. The higher portion of the tray adjacent the protuberance forms the widest entryway for the crawling insects and small rodents, such as house mice.

### CROSS REFERENCE TO RELATED APPLICATIONS

This application is a Continuation-In-Part of my co-pending application, Ser. No. 09/232,258 filed on Apr. 13, 1999 for “Roaches Last Stand,” the full disclosure of which is incorporated by reference herein.

### BACKGROUND OF THE INVENTION

The present invention relates to devices for trapping small pests, such as roaches and the like. More particularly, this invention relates to baited glue traps for trapping cockroaches and small rodents.

The control of roach infestation has been a continuous struggle for building owners and dwellers. Numerous devices for trapping or killing roaches have been patented, marketed, and made available to the public. Many of the devices utilize an adhesive substance with a bait to attract roaches and then entrap them. Many traps use a combination of chemicals for making the bait more attractive to roaches. Some of the known devices use chemicals, for example those containing boric acid, as part of their bait.

While these devices work satisfactorily in many instances, there is a need for easily installed disposable traps that can be positioned in virtually any location around the dwelling and that would be safe to use in homes with children and household pets.

### SUMMARY OF THE INVENTION

It is therefore, an object of the present invention to provide an improved insect trap with a bait.

It is another object of the present invention to provide a trap for small insects, which is safe to use in the house without jeopardizing food, children, and household pets.

A further object of the present invention is to provide a baited insect trap, which is inexpensive to manufacture and easy to use.

These and other objects of the invention are achieved through provision of a tray that is formed by a bottom plate and a continuous side wall extending perpendicularly to the bottom plate. The tray may be rectangular in configuration, although other shapes may be used, if desired. The bottom plate has an inner surface and an outer surface. A contiguous lip extends about the periphery of the side wall and is integrally connected thereto. One portion of the lip forms a first resting surface of the trap.

An integral leg, or protuberance is formed on one side of the lip, extending outwardly therefrom. The protuberance forms a second resting surface of the trap. The protuberance is located on a portion of the lip opposite the first resting surface. When the trap is placed face down, a portion of the lip adjacent to the protuberance becomes elevated from the mounting surface to define a window, though which insects gain access into the trap.

A layer of adhesive material is deposited on the inner surface of the bottom plate and, optionally, on the inner surface of the side wall(s). Suitable bait, such as bread crumbs, cookie crumbs, pancake crumbs, etc., is deposited on the adhesive layer, mostly closer to the first resting surface. The trap is placed in a strategic location in a building with the bottom surface facing down. The inclined upper surface created by the uneven height of the first resting surface defined by a lip and a second resting surface defined by the protuberance, gradually decreases the distance between the bottom surface and the mounting surface where the trap is positioned, making it more likely that the pests would get stuck to the adhesive and become entrapped.

The gradually decreasing opening under the tray allows easy access of the small insects, such as newborn cockroaches, into the trap. The trap may be also used for entrapping small rodents, such as household mice, by positioning the trap with the upper surface contacting a mounting surface and with the inner surface with the adhesive facing upward.

### BRIEF DESCRIPTION OF THE DRAWINGS

Reference will now be made to the drawings, wherein like parts are designated by like numerals, and wherein FIG. 1 is a perspective view of the insect/pest trap of the present invention positioned upside down to show inner surface.

FIG. 2 is a side view showing the trap positioned face down for catching small insects.

FIG. 3 is a perspective view of the trap of the present invention turned upside down to show small insects caught in the trap.

### DETAILED DESCRIPTION OF THE PREFERRED EMBODIMENT

Referring now to the drawings in more detail, numeral 10 designates the insect trap in accordance with the present invention. The trap 10 comprises a shallow tray 12 having a bottom plate 14 and side walls 16, 18, 20, and 22. The walls, 16, 18, 20 and 22 extend perpendicularly to the bottom plate 14 to define an inner cavity 24 of the tray 12.

The bottom plate 14 has an inner surface 26 and an outer surface 28. A quantity of adhesive substance 30 is deposited on the surface 26 of the bottom plate 14 and inner sides of the walls 16, 18, 20, and 22. A discreet quantity of insect or rodent bait 32 (such as bread crumbs, pancake crumbs and the like) is deposited on top of the adhesive layer 30. The bait particles 32 are randomly scattered on the surface 30, preferably closer to the side wall 20, the purpose of which will be disclosed in more detail hereinafter.

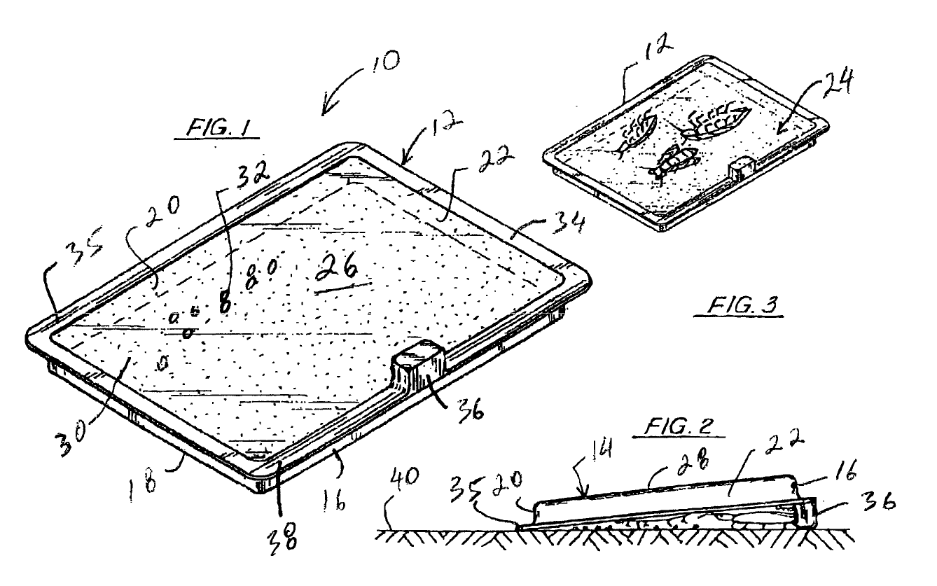

A contiguous lip 34 is integrally connected to the top edges of the side walls 16, 18, 20 and 22 and extends outwardly from the top edges, as shown in FIGS. 1-3. A portion 35 of the lip 34 extends along the side wall 20. The portion 35 forms one of the resting surfaces for the trap 10 (FIG. 2) when the trap 10 is positioned for operation of catching small insects.

A narrow protuberance, or leg 36 is integrally connected to a portion 38 of the contiguous lip 34, extending perpendicularly to the lip 34 and outwardly therefrom. The protuberance 36 serves as a second resting surface for the tray 12 when it is inverted face down as shown in FIG. 2. Since the protuberance 36 extends outwardly from the lip 34, the portion 38 of the lip 34 is elevated above a mounting surface 40 where the trap 10 is positioned upside down.

A gradually decreasing opening is formed under the lip 34, with the largest opening located immediately adjacent the lip portion 38 and the smallest opening being located adjacent the portion 35 of the lip 34. As a result, when the trap 10 is placed in a position with the outer surface 28 of the bottom plate 14 facing upwardly and the bottom surface 26 facing downwardly, the trap 10 presents an inclined, gradually reducing opening under the bottom plate 14.

The structure of the trap 10 ensures that insects do not escape through the opposite side of the trap 10, but will rather be entrapped. Smaller insects will inevitably come into contact with the adhesive layer 30 since roaches tend to always move forward. Since the height of the structure under the bottom plate 14 gradually decreases, the smaller insects will also get entrapped.

In operation, the trap 10 is positioned in any insect-infested location, under the furniture, near the water pipes and other similar locations. When placed upside down, as shown in FIG. 2, the trap 10 presents an open trap, with the lip portion 38 defining larger opening on both sides of the protuberance 36 to allow insects to crawl under the bottom plate 14.

Once inside, the insect will tend to move towards the bait 32, which is positioned closer to the narrow opening near the side wall 20. Once the insect reaches the adhesive layer 30, it will get stuck. The consumer can easily determine whether the trap 10 has entrapped any of the insects by picking up the trap 10, turning it face up and looking on the adhesive surface 30.

The trap 10, being inexpensive to manufactures, can be easily disposed with the insects stuck to the adhesive layer 30. It is envisioned that the adhesive layer 30 can entrap the insect by the legs or by the body. In any case, once the insect contacts the surface 30, it will not be able to escape from the trap 10. If the insect crawls along the side walls 16, 18, 20 and 22 to reach the bait 32, the adhesive layer on the inner surface of the side walls will cause the insects to become glued inside the trap 10.

The bait 32 can be any food product, for example breadcrumbs, dried pancake crumbs, cookie crumbs and the like. Of course, other bait substances that are safe to children and household pets can be used. The adhesive substance is selected from a group of glues that retain their adhesive properties, without drying for a number of days.

The tray 12 can be made of any suitable material, preferably a material that lends itself to molding, such as plastic. At the same time, the material should be hard enough to allow the tray 12 to retain its shape and not to collapse. At the same time, the trap 10 is lightweight enough to be easily transported and placed in any insect-infested location.

The trap 10 may be also used to trapping small rodents, such as house mice. In such a case, the trap 10 is turned with the bottom surface 26 facing up and the outer surface 28 contacting the surface 40. The bait 32 can be scattered anywhere on the adhesive layer 30, preferably closer to the center of the bottom plate 14. The rodent, being attracted by the smell of the bait will step into the adhesive layer and will get entrapped thereby. Once a rodent contacts the adhesive surface 30 it will get stuck inside the tray and may be disposed of, together with the tray, in the usual manner.

Many other changes and modifications can be made in the design of the present invention without departing from the spirit thereof. I therefore pray that my rights to the present invention be limited only by the scope of the appended claims.

I claim:

1. A trap for pests, such as cockroaches, comprising:
a tray having a bottom plate, said bottom plate having an inner surface and an outer surface;
a side wall extending perpendicularly to the bottom plate;
a contiguous lip integrally connected to an edge of the side wall and extending along the periphery thereof, a portion of said lip forming a first resting surface of the tray;
an outwardly extending protuberance secured to the lip, said protuberance forming a second resting surface of said tray opposite the first resting surface;
a layer of adhesive substance deposited on the inner surface of the bottom plate; and
a bait deposited on the adhesive layer for attracting pests to the trap.

2. The device of claim 1, wherein said protuberance elevates a portion of the lip adjacent to the protuberance above a mounting surface where the tray is positioned with the outer surface facing upwardly.

3. The device of claim 1, wherein said second resting surface elevates the portion of the tray adjacent to the protuberance above a mounting surface such that the bottom plate is downwardly inclined towards the first resting surface.

4. The device of claim 1, wherein a gradually reducing opening is defined between a mounting surface where the tray is positioned and the bottom plate to allow pests to crawl under the bottom plate into the trap.

5. The device of claim 1, wherein said bait is made from material attractive to pests.

6. A trap for pests, such as cockroaches, comprising:
a tray having a bottom plate defining an inner surface and an outer surface;
a side wall unitary connected to the bottom plate and extending perpendicularly to the bottom plate;
a contiguous lip extending along the periphery of the side wall, a portion of said lip forming a first resting surface of the tray;
a narrow protuberance extending perpendicularly and outwardly from the lip, said protuberance forming a second resting surface of the trap when said trap is placed with the outer surface of the bottom plate facing upwardly;
a layer of adhesive substance deposited on the inner surface of the bottom plate; and
a pest-attracting bait deposited on the adhesive layer for attracting pests to the trap; and
wherein said tray defines a gradually decreasing opening to allow pests to crawl under the bottom plate into the trap.

7. A method of trapping insects, such as cockroaches, comprising the steps of:
providing a shallow tray having a bottom plate, a continuous side wall, a contiguous lip extending along the periphery of the side wall and a narrow protuberance extending outwardly from said lip;
depositing an adhesive substance on an inner surface of the bottom plate;
depositing a bait substance on the layer of the adhesive substance;
placing the trap on a mounting surface with an outer surface of the bottom plate facing upwardly, while resting the trap on a portion of said lip and on said protuberance, thereby defining a gradually decreasing window under said lip to allow insects to crawl through the opening and become entrapped in the adhesive substance deposited in the tray.

8. The method of claim 7, wherein a portion of said lip defines a first resting surface and said protuberance defines a second resting surface.

9. The method of claim 8, wherein said protuberance is located opposite said first resting surface, such that the outer surface of said bottom plate defines an inclined surface, with the highest point being located adjacent said protuberance.
